(19) United States
(12) Patent Application Publication
(10) Pub. No.: US 2005/0171762 A1
(43) Pub. Date: Aug. 4, 2005

(54) Creating records of patients using a browser based hand-held assistant

(75) Inventors: Patrick Ryan, Folsom, CA (US); Steve Neptune, Granite Bay, CA (US); Paul Bakken, Folsom, CA (US); Andrea Packheiser, New Castle, CA (US)

Correspondence Address: Ross Spencer Garsson;Winstead Sechrest & Minick, PO Box 50784, Dallas, TX, 75201, US

(73) Assignee: Professional Pharmaceutical Index, Grainite Bay, CA (US)

(21) Appl. No.: 10/506,873

(22) PCT Filed: Mar. 5, 2003
(86) PCT No.: PCT/US03/07013

Related U.S. Application Data
(60) Provisional application No. 60/362,024, filed on Mar. 6, 2002.

(51) Int. Cl. G06F 17/60; G10L 11/00; G06F 15/00

(52) U.S. Cl. 704/200; 705/2

(57) ABSTRACT

A method, computer program product and system for creating records using a hand-held device capable of recording a voice file. A server may receive a request to select an encounter template, e.g., knee template, from the user of a hand-held computer. The server may transmit one or more screens of the selected encounter template to the hand-held computer. The server may receive a request to generate a voice file from the hand-held computer. A tag file may be generated in response to the request to generate a voice file where the tag file associates the voice file to be generated with the appropriate field the transcription of the voice file is to be inserted in the selected encounter template. Upon transcription of the voice file, the server may insert the transcription in the appropriate field in the template created by the user using the tag file.

### CROSS REFERENCE TO RELATED APPLICATION

This application is related to the following commonly owned copending U.S. patent application:

Provisional Application Ser. No. 60/362,024, “System, Apparatus, and Method for Point of Service Diagnosis Data Processing”, filed Mar. 5, 2002, and claims the benefit of its earlier filing date under 35 U.S.C. 119(e).

### TECHNICAL FIELD

The present invention relates to the field of healthcare systems, and more particularly to allowing a healthcare provider to create records using a browser based hand-held assistant capable of recording a voice file to be later transcribed and inserted in the associated record.

### BACKGROUND INFORMATION

Healthcare providers, such as physicians, create large volumes of patient information during the course of their business at healthcare facilities, such as hospitals, clinics, laboratories and medical offices. For example, when a patient visits a physician for the first time, the physician generally creates a patient file including the patient's medical history, current treatments, medications, insurance and other pertinent information. This file generally includes the results of patient visits, including laboratory test results, the physician's diagnosis, medications prescribed and treatments administered.

Physicians often use paper based forms and charts to document their observations and diagnosis. These paper based forms may be limiting by not allowing the physician the flexibility of inserting information the physician deems important Further, these paper based forms contain standard questions that are not necessarily logically relevant to the particular encounter with the patient Further, these paper based forms are time consuming to fill-out and easy to tear or lose.

Physicians may also dictate their observations and diagnosis using a dictation device. However, the transcribed dictation is often inserted in the patient file as a separate document and not part of the paper based form filled out by the physician. By being a separate paper, the transcribed dictation is subject to mishandling whereby the transcription is associated with a wrong patient or encounter.

If physicians were able to create their own forms containing the information they deem important for each particular encounter with a particular patient, the patient file would be more complete by containing the physicians complete observations and diagnosis of the patient for that particular encounter. Further, if physicians could electronically create their own forms instead of using paper based forms, the physicians may spend less time filling out forms. Further, by electronically creating their own forms instead of using paper based forms, the forms are less likely to be lost Further, if physicians were able to create a voice file that is electronically associated with a record of the encounter and later transcribed and inserted in the form created by the physician, then the opportunity for mishandling would be reduced.

Therefore, there is a need in the art for a mechanism to allow a healthcare provider, e.g., physician, to create records electronically such as using a browser based hand-held assistant capable of recording a voice file to be later transcribed and inserted in the associated record.

### SUMMARY

The problems outlined above may at least in part be solved in some embodiments by a server configured to generate a tag file in response to a request from the user, e.g., physician, of a hand-held device, e.g., Personal Digital Assistant (PDA), to record a voice file. The tag file associates the voice file to be recorded with a particular field in a record of the template the user is creating. The tag file may be transmitted to the user of the hand-held device by the server. The server may receive the voice file along with the tag file upon the user completing the recording of the voice file. Upon transcription of the voice file, the server may insert the transcription in the appropriate field in the template created by the user using the tag file.

In one embodiment of the present invention, a method for creating records using a hand-held device capable of recording a voice file may comprise the step of receiving a request to select an encounter template. The method may further comprise transmitting one or more screens of the selected encounter template and receiving a request to generate a voice file to be inserted at a selected field in one of the transmitted screens. A tag file may be generated in response to the request to generate a voice file where the tag file associates the voice file with the selected field in one of the transmitted screens into which the voice file is to be inserted. The method may further comprise transmitting the tag file to a requesting device.

The foregoing has outlined rather broadly the features and technical advantages of one or more embodiments of the present invention in order that the detailed description of the invention that follows may be better understood. Additional features and advantages of the invention will be described hereinafter which form the subject of the claims of the invention.

### BRIEF DESCRIPTION OF THE DRAWINGS

A better understanding of the present invention can be obtained when the following detailed description is considered in conjunction with the following drawings, in which:

FIG. 1 illustrates a system configured in accordance with an embodiment of the present invention;

FIG. 2 illustrates an embodiment of the present invention of a server in the system;

FIG. 3 illustrates an embodiment of the present invention of a hand-held computer in the system;

FIG. 4 is a flowchart of a method for creating records using a browser hand-held computer in accordance with an embodiment of the present invention;

FIG. 5 is a data flow diagram illustrating the interactions between the databases and software in the server and the interactions between the server and the hand-held computer for the method for creating records using a browser hand-held computer in accordance with an embodiment of the present invention;

FIG. 6 is a data flow diagram illustrating the interactions between the server and the hand-held computer when the user of the hand-held computer selects to record a voice file in accordance with an embodiment of the present invention; and

FIG. 7 is a flowchart of a method for the user of the hand-held computer to record a voice file at a selected field in an encounter template created by the user in accordance with an embodiment of the present invention.

### DETAILED DESCRIPTION

The present invention comprises a method, computer program product and system for creating records using a hand-held device capable of recording a voice file. A server may receive a request to select an encounter template from the user of a hand-held computer, e.g., Personal Digital Assistant (PDA). The server may transmit one or more screens of the selected encounter template to the hand-held computer. The server may receive a request to generate a voice file to be inserted at a selected field in one of the transmitted screens. A tag file may be generated in response to the request to generate a voice file where the tag file associates the voice file to be generated with the selected field in one of the transmitted screens into which the voice file is to be inserted. The server may transmit the generated tag file to the hand-held computer.

Although the present invention is described in the context of a physician's hand-held assistant embodiment that uses technology to record field observations within the health care environment, it is noted that the principles of the present invention may be applied to alternative embodiments such as optometry, paramedical/EMT, radiology, law enforcement, education, insurance adjusters, service/repair personnel, census takers, etc. It is further noted that that embodiments applying the principles of the present invention to such alternative embodiments would fall within the scope of the present invention.

In the following description, numerous specific details are set forth such as specific protocols to provide a thorough understanding of the present invention. However, it will be apparent to those skilled in the art that the present invention may be practiced without such specific details. In other instances, well-known circuits have been shown in block diagram form in order not to obscure the present invention in unnecessary detail. For the most part, details considering timing considerations and the like have been admitted inasmuch as such details are not necessary to obtain a complete understanding of the present invention and are within the skills of persons of ordinary skill in the relevant art

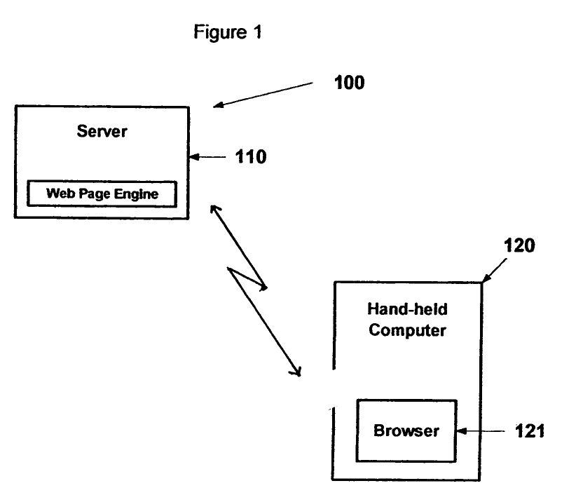

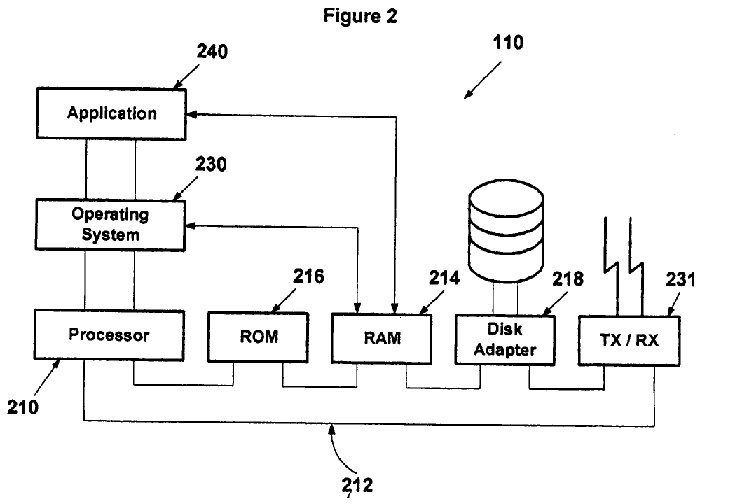

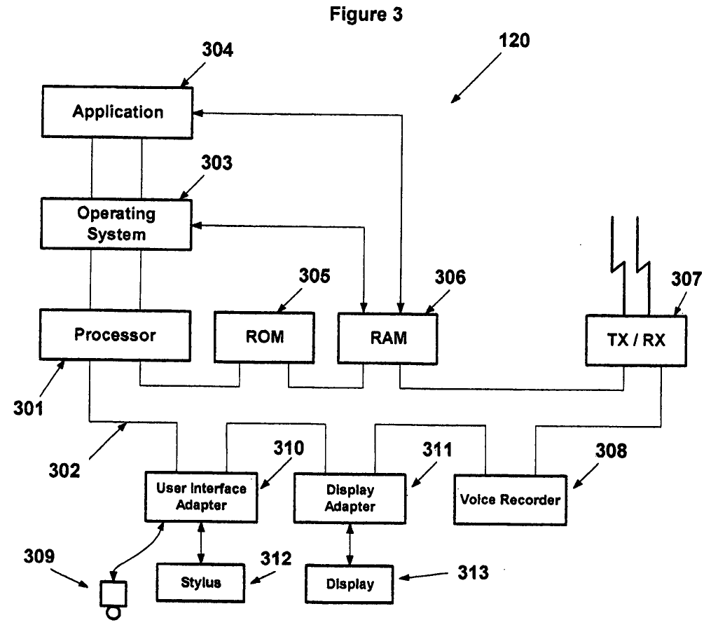

Referring to FIG. 1, FIG. 1 illustrates an embodiment of the present invention of a system 100. System 100 may comprise a client 120, e.g., hand-held computer, that may be used by a user, e.g., physician, to communicate with a server 110 through a wireless medium. Server 110 is described further below in conjunction with FIG. 2. Client 120 is described further below in conjunction with FIG. 3. It is noted that the communication link between client 120 and server 110 may be any medium type, e.g., wired, and that FIG. 1 is illustrative. It is further noted that FIG. 1 illustrates client 120 as being a hand-held computer. However, client 120 may be any type of device, e.g., wireless, cell phone, personal computer system, workstation, Internet appliance, Personal Digital Assistant (PDA), palmtop, smart phone, Pocket PC, configured with the capability of communicating with server 110. It is further noted that server 110 may refer to a software implementation, a general purpose data processing system or a stand alone hardware device. It is further noted that system 100 may be any type of system that has at least one server and at least one client and that FIG. 1 is not to be limited in scope to any one particular embodiment

Server 110 may comprise a web page engine 111 for maintaining and providing access to an Internet web page which is enabled to forward a Hyper-Text Mark-up Language (HTML) file to a web browser 121 of client 120. Web browser 121 may be configured for reading and interpreting web pages. While the illustrated client engine is a web browser 121, those skilled in the art will recognize that other client engines may be used in accordance with the present invention and that the principles of the present invention may be implemented using other languages for displaying document elements with distinctive formats. These may include, for example, XML (Extensible Markup Language) or SGML (Standard Generalized Markup Language).

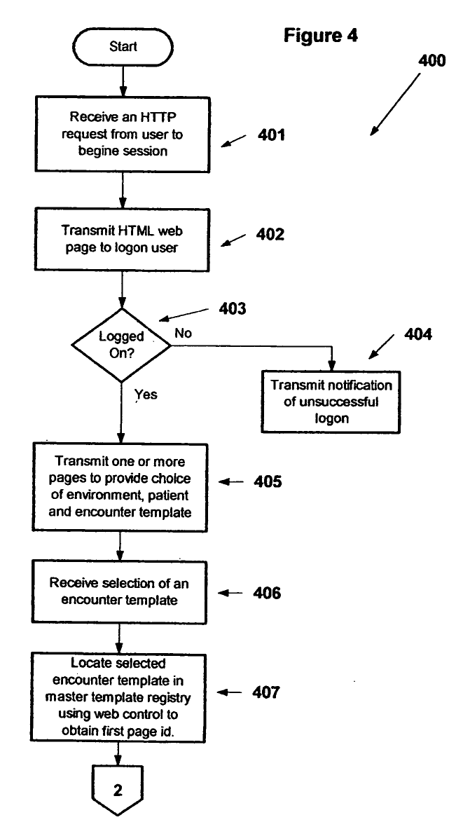

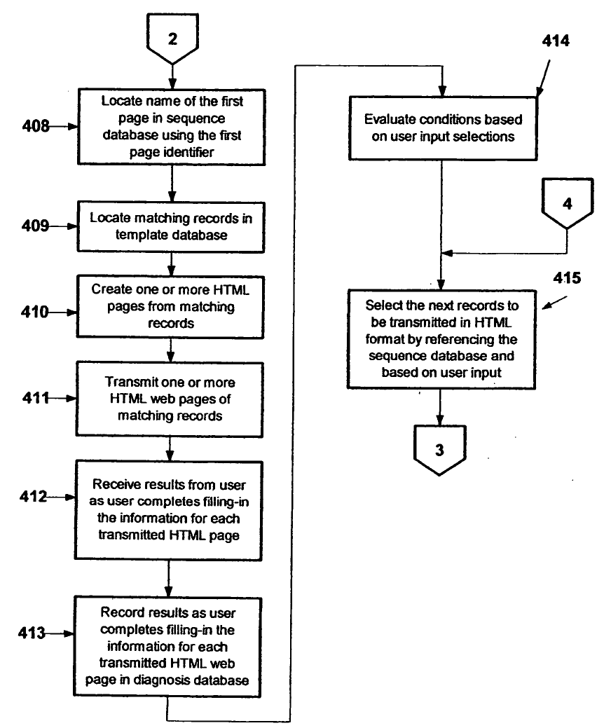

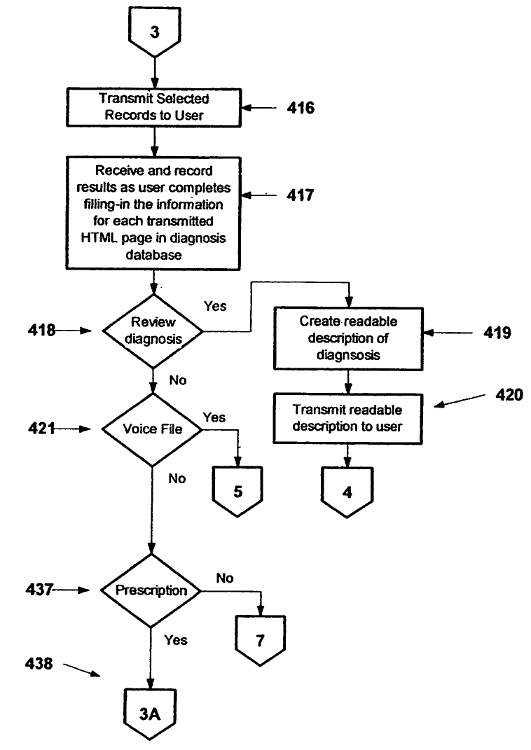

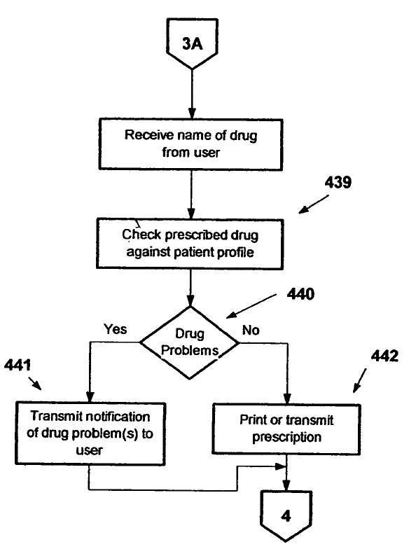

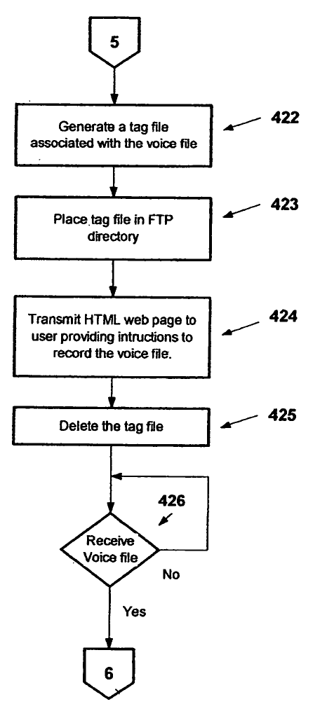

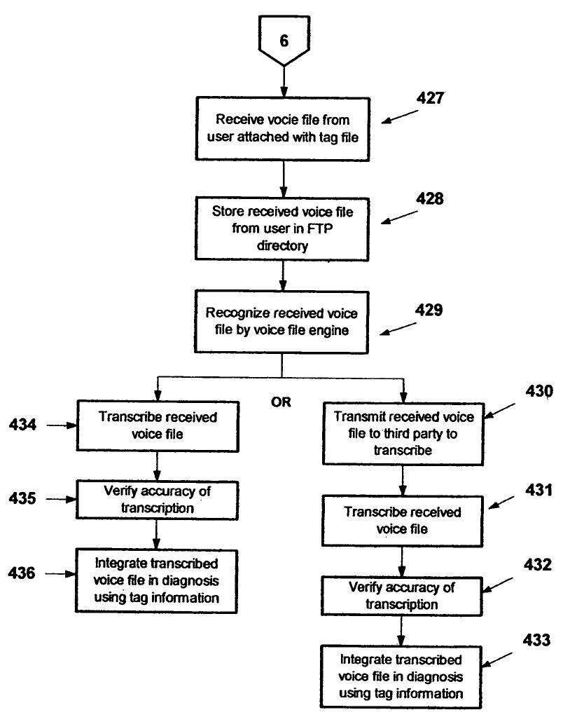

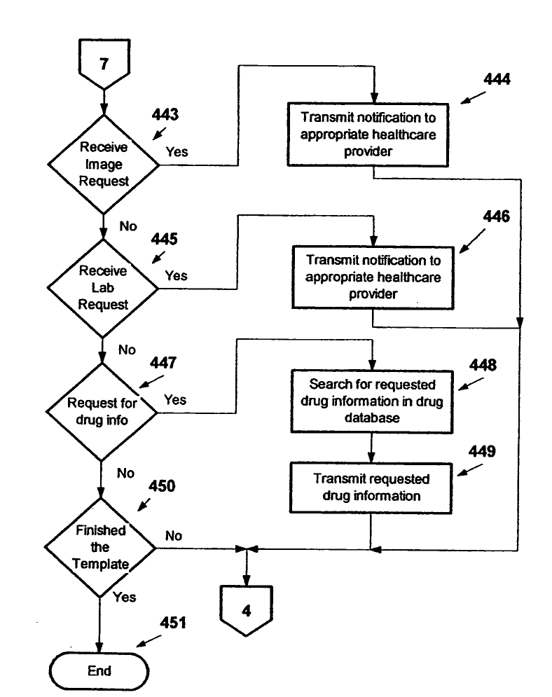

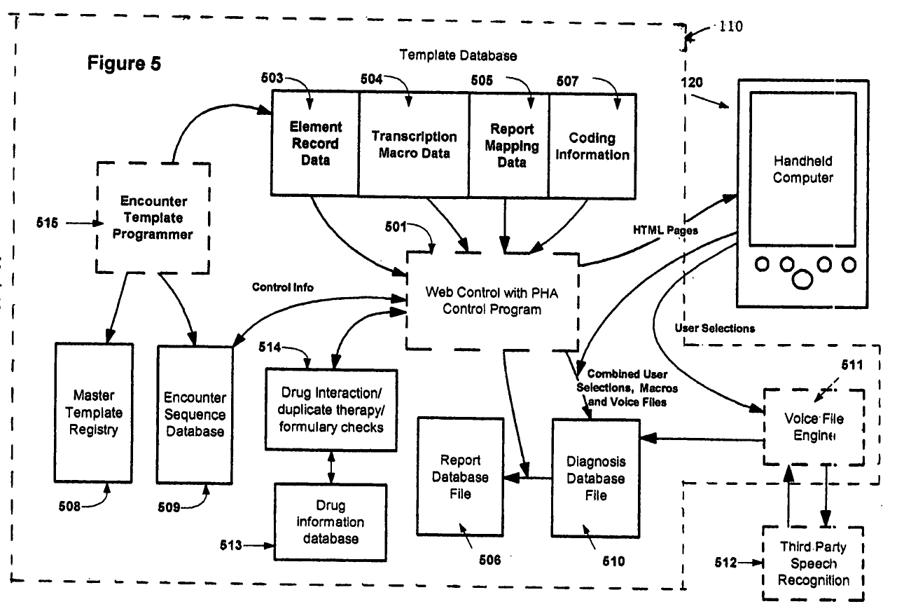

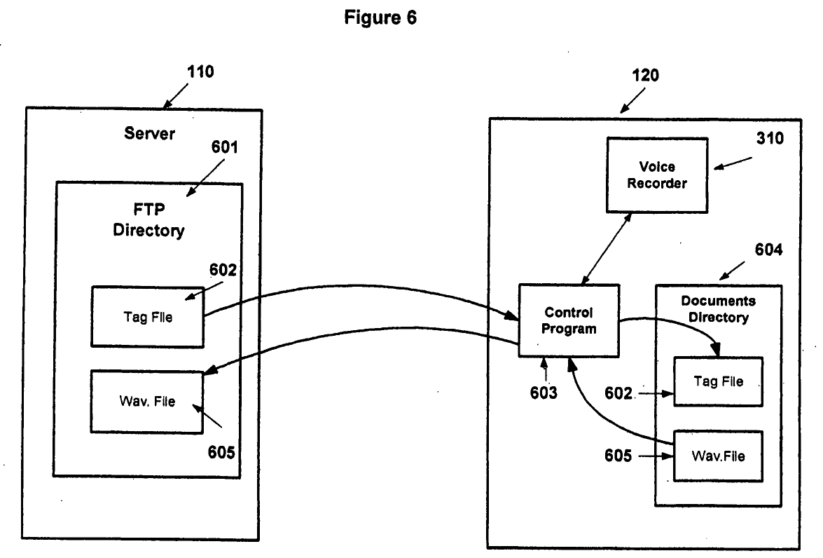

Turning now to FIG. 2, FIG. 2 illustrates an embodiment of the present invention of server 110. Server 110 may comprise a processor 210 coupled to various other components by system bus 212. An operating system 230 may run on processor 210 and provide control as well as coordinate the function of the various components of FIG. 2. An application 240 in accordance with the principles of the present invention may run in conjunction with operating system 230 and provide output calls to operating system 230 where the output calls implement the various functions or services to be performed by application 240. An application 240 may include, for example, a program (including the web control, encounter template programmer and voice file engine as discussed further below) for creating records including inserting a transcribed voice file in the appropriate field in a record as described in association with FIGS. 4-6. It is noted that the steps of the method for creating records performed by the program mentioned above may in an alternative embodiment be implemented in hardware such as in an Application Specific Integrated Circuit (ASIC). Read only memory (ROM) 216 may be coupled to system bus 212 and include a Basic Input/Output System (“BIOS”) that controls certain basic functions of server 110. Random access memory (RAM) 214, disk adapter 218 and transceiver 234 may also be coupled to system bus 212. It should be noted that software components including operating system 230 and application 240 may be loaded into RAM 214 which may be the main memory for server 110. RAM 214 also may be configured to store databases, e.g., template database, diagnosis database, report database, drug information database, master template registry, drug interaction/duplicate therapy/formulatory checker, File Transfer Protocol (FOP) directory, as discussed in conjunction with FIGS. 5 and 6. Disk adapter 218 may be an integrated drive electronics (“IDE”) adapter that communicates with disk units 220. It is noted that the program of the present invention that creates records including inserting a transcribed voice file in the appropriate field in a record as described in FIG. 4 may reside in disk drive 220 or in application 240. It is further noted that disk drive 220 may be configured to store databases, e.g., template database, diagnosis database, report database, drug information database, master template registry, drug interaction/duplicate therapy/formulatory checker, FTP directory, as discussed in conjunction with FIGS. 5 and 6. Transceiver 234 may be configured to receive/transmit data from/to client 120.

Implementations of the invention include implementations as a computer system programmed to execute the method or methods described herein, and as a computer program product. According to the server implementations, sets of instructions for executing the method or methods may be resident in the random access memory 214 of one or more computer systems configured generally as described above. Until required by server 120, the set of instructions may be stored as a computer program product in another computer memory, for example, in disk drive 220 (which may include a removable memory such as an optical disk or floppy disk for eventual use in disk drive 220). Furthermore, the computer program product may also be stored at another computer and transmitted when desired to the user's workstation by a network or by an external network such as the Internet One skilled in the art would appreciate that the physical storage of the sets of instructions physically changes the medium upon which it is stored so that the medium carries computer readable information. The change may be electrical, magnetic, chemical or some other physical change.

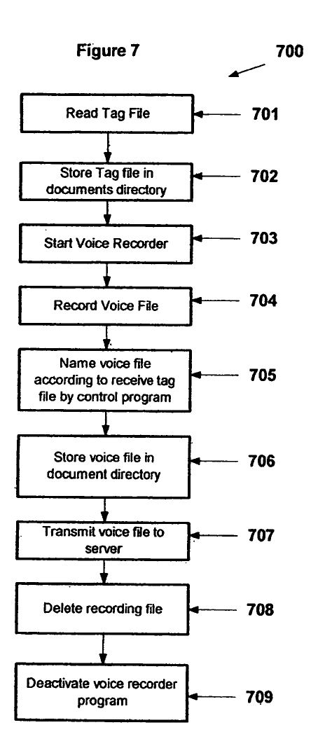

Turning now to FIG. 3, FIG. 3 illustrates an embodiment of the present invention of hand held computer 120, e.g., a PDA, palmtop, smart phone, Pocket PC, possessed by a user, e.g., physician. Hand held computer 120 may comprise a processor 301 coupled to various other components by a bus 302. An operating system 303 may run on processor 301 and provide control as well as coordinate the function of the various components of FIG. 3. An application 304 in accordance with the principles of the present invention may run in conjunction with operating system 303 and provides output calls to operating system 303 where the output calls implement the various functions or services to be performed by application 304. Application 304 may include for example, web browser 121 (FIG. 1), and a program for recording a voice file as described in conjunction with FIGS. 6 and 7. Read only memory (ROM) 305 may be coupled to bus 302 and include a Basic Input/Output System (“BIOS”) that controls certain basic functions of hand held computer 120. Random access memory (RAM) 306 and transceiver 307 may also be coupled to bus 302. It should be noted that software components including operating system 303 and application 304 may be loaded into RAM 306 which may be the hand held computer's 120 main memory. RAM 214 may be configured to store databases, e.g., documents directory, as discussed in conjunction with FIG. 6. Transceiver 307 may be configured to receive/transmit data from/to server 110.

Hand held computer 120 may further comprise a voice recorder 308 coupled to bus 302. Voice recorder 308 may be configured to record a voice from the user of hand-held computer 120 via microphone 309.

Input/Output devices may also be connected to bus 302 via a user interface adapter 310 and display adapter 311. A microphone 309 and a stylus 312 may be connected to bus 302 through user interface adapter 310. A display 313 may be connected to bus 302 by display adapter 311. In this manner, a user may be capable of inputting to hand held computer 120 through microphone 309, stylus 312 and receiving output from hand held computer 120 via display 313.

Implementations of the invention include implementations as a computer system programmed to execute the method or methods described herein, and as a computer program product According to the computer system implementation, sets of instructions for executing the method or methods are resident in the random access memory 306 of one or more computer systems configured generally as described above. Further, the computer program product may also be stored at another computer and transmitted when desired to the user's workstation by a network or by an external network such as the Internet. One skilled in the art would appreciate that the physical storage of the sets of instructions physically changes the medium upon which it is stored so that the medium carries computer readable information. The change may be electrical, magnetic, chemical, biological or some other physical change.

Turning now to FIG. 4, FIG. 4 is a flowchart of one embodiment of the present invention of a method 400 for creating records using a browser based hand-held assistant 120 (FIGS. 1 and 3) capable of recording a voice file to be later transcribed and inserted in the associated record. It is noted that one of ordinary skill in the art will readily recognize that method 400 may include other and/or additional steps that, for clarity, are not depicted. It is further noted that method 400 may be executed in a different order presented and that the order presented in the discussion of FIG. 4 is illustrative. It is further noted that certain steps in method 400 may be executed in a substantially simultaneous manner.

Referring to FIG. 4, in conjunction with FIGS. 1-3, in step 401, server 110 receives an HTTP request from the user of hand-held computer 120 to begin a session. Upon receiving the HTTP request, server 110, in step 402, transmits an HTML web page to hand-held computer 120 to logon the user to access server 110 to create encounter templates as described below. In step 403, a determination is made by server 110 as to whether the user successfully logged onto server 110. If the user did not successfully log onto server 110, then, in step 404, server 110 transmits to hand-held computer 120 a notification of an unsuccessful attempt to logon onto server 110. Server 110 may also transmit a request for the user to try again to begin a session in step 404.

If the user did successfully log onto server 110, then, in step 405, server 110 transmits one or more HTML web pages to provide the choice of environment, basic information on the patient and the encounter template to create. The choice of environment may include the place of the patients visit and the expected duration of the patient's stay. Examples of a type of environment include an office visit, emergency room, outpatient and overnight stay at the hospital. Encounter may refer to the type of injury or disease exhibited by the patient. For example, the patient may have sustained a knee injury. The encounter template may include one or more records in html (or other markup language) format that may be provided by server 110 for the user of hand-held computer 120 to diagnose the encounter. A list of the templates may be maintained in a master template registry as illustrated in FIG. 5.

Turning now to FIG. 5, FIG. 5 illustrates an embodiment of the present invention of a data flow diagram illustrating the interconnections between the databases and software in server 110. Server 110 may comprise software, referred to herein as “web control” 501, configured to control the interactions between the databases within server 110 and the interactions between server 110 and hand-held computer 120. Server 110 may further comprise software, referred to herein as “encounter template programmer” 515, configured to create the encounter template set(s) that may be selected by the user of hand-held computer 120 by referencing a sequence database 509 and based upon the user's input. A methodology that may be used in conjunction with encounter template programmer 515 will be described further below.

Server 110 may further comprise a template database 502 configured to store data associated with various encounter templates. Template database 502 may comprise an element record data portion 503 configured to store elements, e.g., titles, dropdowns, checkboxes, fill-ins, displayed to the user of hand-held computer 120 on each HTML web page for each encounter template that may be transmitted to hand-held computer 120. Element record data portion 503 may further contain fields that describe to web control 501 how to form the HTML web pages. For example, a “data type” field may inform web control 501 what kind of element it will create. A “c” in the data type field may inform web control 501 to create a “checkbox” element. A “field tag” may become the name or text displayed with the checkbox. An “f” in the data type field may inform web control 501 to create a “fill-in” element. A “q” in the data type field may inform web control 501 to create a “question” element An illustrative element list is included herein as Appendix A.

Template database 502 may further comprise a transcription data portion 504. Transcription data portion 504 may be macro data used to create the textual information that may become part of a final report where the final report may include a complete encounter template created by the user including any voice files recorded and transcribed. Each element that is created for the screen may be linked to a macro statement that, based on user input, will become part of the textual result. The final destination for the textual result may be controlled by the report mapping data portion 505. These macro statements are inserted into a report database 506 from which the report is generated.

To evaluate the extent to which the physician has performed the exam is determined by a coding information portion 507 of template database 502. Elements of the exam may be related to values, which may be evaluated at the end of the encounter to provide the physician an idea of the physician's level of evaluation and management coding. Evaluation and management coding is an indicator used to evaluate the healthcare provider, e.g., physician. Typically, the evaluation and management coding includes information about the level of service provided by the healthcare provider such as the content of the service provided, the nature of the presenting problem(s) and the time required to provide the service.

Returning to FIG. 4, in conjunction with FIGS. 1-3 and 5, in step 406, server 110 receives from the user of hand-held computer 120 a selected template. In step 407, the selected template is located in master template registry 508 and a first page identifier is obtained. Step 407 may be performed by web control 501. In step 408, this identifier is used to locate the name of the first page in a sequence database 509 configured to store a sequence of HTML web pages to be provided to the user for each particular encounter template. Step 408 may also be performed by web control 501. An illustrative set of screen shots for the knee template is included herein as Appendix B. In step 409, the one or more matching records in template database 502 is located in sequence database 509. In step 410, one or more HTML web pages of the one or more matching records are created. In step 411, these one or more HTML web pages are transmitted to hand-held computer 120. Steps 409-411 may also be performed by web control 501.

In step 412, server 110 receives results from the user of hand-held computer 120 as the user completes filling-in the information on each received HTML web page. In step 413, server 110 records the results from the user of hand-held computer 120 in a diagnosis database 510 as the user completes filling-in the information on each received HTML web page. Based on user input selections, conditions may be evaluated in step 414. For example, the condition of SSL may refer to a “Screen Selection List” where the user, such as a physician, may select particular pages, e.g., allergic, neurological, of an encounter template to be created. The pages or screens selected by the user may be selected in sequence database 509. The condition of branching may include to providing the user a range of choices in the diagnosis that results in a different sequence of HTML web pages being subsequently transmitted. For example, if the physician or nurse practitioner selected a crushed knee versus a pulled knee, different HTML web pages would be created and transmitted by web control 501 to the user thereby allowing the user to create a unique encounter template. In another example, the condition may be a voice file request as will be discussed further herein below. In another example, the condition may be a prescription request as will be discussed herein further below. In another example, the condition may be a template call. A template call may refer to a function invoked that allows the user to branch to another template. For example, the user may invoke a function to suspend the current template being displayed and to start another template to be generated.

In step 415, the next records or HTML web pages to be transmitted to the user of hand-held computer 120 are selected by encounter template programmer 515 by referencing sequence database 509 and based upon the user's input, i.e., based upon the user's selection when provided a list of choices as discussed above. These elements are then transmitted to hand-held computer 120 via web control 501 in step 416. This process continues until the end of the sequence is reached. In step 417, server 110 receives and records the results from the user of hand-held computer 120 in a diagnosis database 510 as the user completes filling-in the information on each transmitted HTML web page.

If server 110 receives a request to review the current diagnosis, then decision block 418 proceeds by the “yes” branch to step 419. In step 419, readable description of the diagnosis so far inputted is created. In one embodiment, a readable description of the diagnosis may be created by sending the information entered by the user which may be stored in the diagnosis database 510 to the report database 506. In step 420, web control 501 transmits the readable description of the current diagnosis of the current encounter template to the user of hand-held computer 120.

If, however, server 110 did not receive a request to review the current diagnosis, then, in step 421, a determination is made by server 110 as to whether a request to generate a voice file has been received. If server 110 received a request to generate a voice file, then, in step 422, server 110 generates a tag file associated with a voice file where the tag file may include a tracking number, a voice file sequence number, a doctor's HIPPA identifier, a topic, and an Internet Protocol (IP) address.

The tracking number may include a unique number assigned to the voice file to be created that indicates the particular field the voice file is to be inserted on a particular HTML web page of the encounter template. For example, the user may be presented with a series of options including the option of inserting a voice file (textual transcription of a voice recording). The user may select to insert a voice file to include a more complete diagnosis or observation than may be provided by selecting one of the options presented to the user.

The voice file sequence number may refer to the particular voice file, e.g., first, second, third voice file, to be inserted in the current encounter template. The doctor's HIPPA identifier may include the unique HIPPA number each physician is assigned. The topic may refer to the medical discipline, e.g., internal medicine, gynecology. The EP address may be used for routing the text file to a service to perform proofing of the transcribed voice file.

In step 423, web control 501 places the generated tag file in an FTP directory as illustrated in FIG. 6. FIG. 6 illustrates a data flow diagram illustrating the interactions between server 110 and hand-held computer 120 when the user of hand-held computer 120 selects to record a voice file in accordance with an embodiment of the present invention. Referring to FIG. 6, server 110 may comprise an FTP directory 601 where the generated tag file 602 may temporarily be stored.

Returning to FIG. 4, in conjunction with FIGS. 5-6, in step 424, web control 501 transmits tag file 602 to hand-held computer 120 to be received by control program 603 in hand-held computer 120. In step 425, tag file 602 is deleted. In one embodiment, tag file 602 is deleted by web control 501 upon receiving from control program 603 of hand-held computer 120 a notification of receiving tag file 602. In step 426, the process loops, breaking out of the loop if a voice file is received from hand-held computer 120. The method of the user recording a voice file in hand-held computer 120 is provided below.

Referring to FIG. 7, FIG. 7 is a flowchart of a method 700 for the user of hand-held computer 120 to record a voice file to be inserted at a selected field on a screen being viewed by the user. Referring to FIG. 7, in conjunction with FIG. 6, in step 701, control program 603 reads the received tag file. In step 702, the received tag file is stored in a documents directory 604 of hand-held computer 120. In step 703, voice recorder 308 is activated by control program 603 to start recording the user's dictation. In step 704, the user's dictation is recorded. It is noted that in one embodiment, the user of hand-held computer 120 may be provided with the option of recording the user's dictation at a later time. The user may then at a later time select to record a dictation upon which control program 603 generates a request to server 110 to record a voice file. In step 705, the recorded voice file may be named according to the received tag file by control program 603. In one embodiment, the voice file may be named by using the user's HIPPA identifier which may be associated with a particular voice pattern. In one embodiment, the HIPPA identifier may be prestored in hand-held computer 120 (FIGS. 1 and 3) such as in ROM 305 (FIG. 3). In step 706, the recorded voice file 605, is stored in documents directory 604 by control program 603. The voice file may be in a standard file format for digital audio data such as a WAV file, a MPEG file, an AIFF file, etc. In step 707, control program 603 transmits the recorded voice file 605 to server 110. In step 708, control program 603 deletes recording file 605 such as to save memory space. In step 709, voice recorder 301 is deactivated.

It is noted that one of ordinary skill in the art will readily recognize that method 700 may include other and/or additional steps that, for clarity, are not depicted. It is further noted that method 700 may be executed in a different order presented, e.g., step 708 may be executed prior to step 709, and that the order presented in the discussion of FIG. 7 is illustrative. It is further noted that certain steps in method 700 may be executed in a substantially simultaneous manner.

Returning to FIG. 4, in conjunction with FIGS. 1-3 and 5-6, in step 427, web control 501 receives a voice file 605 attached with the tag file from hand-held computer 120. In step 428, the received voice file 605 is stored in a directory, which in an embodiment of the present invention may be an FTP directory 601. In step 429, voice file engine 511 is configured to recognize the received voice file 605. Method 400 may proceed to one of two set of steps.

In one embodiment, method 400 may proceed by voice file engine 511 transmitting the received voice file 605 to a third party transcription service 512 in step 430. In step 431, voice file engine 511 receive the transcribed voice file from the third party transcription service 512. In step 432, the transcribed voice file is verified for accuracy. In step 433, voice file engine 511 integrates the transcribed voice file in the diagnosis using the associated tag file. As discussed above, the tag file may contain information used to insert the transcribed voice file in the appropriate field in one of the HTML pages of the encounter template.

In an alternative embodiment, method 400 may proceed by voice file engine 511 transcribing the received voice file in step 434. In one embodiment, voice file engine 511 may contain software configured to transcribe voice files into text An example of commercially available voice recognition software is ViaVoice®, a product of IBM Corporation, Armonk, N.Y. In step 435, the transcribed voice file is verified for accuracy. In step 436, voice file engine 511 integrates the a bed voice file in the diagnosis using the associated tag file. As discussed above, the tag file may contain information used to insert the transcribed voice file in the appropriate field in one of the HTML pages of the current encounter template.

Returning to step 421 of FIG. 4, in conjunction with FIG. 5, if server 110 did not receive a request to generate a voice file, then, in step 437, a determination is made as to whether server 110 received a request to write a prescription. If so, then web control 501 of server 110, in step 438, receives the prescribed drug from the user of hand-held computer 120. The prescribed drug may include the name of the drug, the dosage, information about generic substitutes, etc. In step 439, web control 501 checks the prescribed drug against the patient profile using drug interaction/duplicate therapy/formulatory checker 514. A determination is made in step 440 by drug interaction/duplicate therapy/formulatory checker 514 as to whether there are any problems, e.g., patient allergic to prescribed drug, drug interaction, with prescribing this drug for the patient. If there is a problem with prescribing this drug for the patient, then, in step 441, web control 501 transmits a notification to hand-held computer 120 indicating that there is a problem with prescribing this drug for the patient. If there is no problem with prescribing this drug for the patient, then, in step 442, the prescription is printed or transmitted to the appropriate healthcare provider, e.g., pharmacy.

If server 110 did not receive a request to write a prescription, then, in step 443, a determination is made as to whether server 110 received an image request, e.g., x-rays, CT scan, Magnetic Resonance Imaging (MRI), Magnetic Resonance Angiograhy (MRA), ultrasound, nuclear medicine, to be performed on a particular patient, e.g., x-ray right knee on patient If server 110 received an image request, web control 501 transmits a notification in step 444 to the appropriate healthcare provider such as a radiologist or other imaging technicians.

If server 110 did not receive an image request, then, in step 445, a determination is made as to whether server 110 received a lab request, e.g., blood test for patient xyz, to be performed on the patient If server 110 received a lab request, web control 501 transmits a notification in step 446 to the appropriate healthcare provider, e.g., lab technicians, to prepare to perform laboratory work on the patient.

If server 110 did not receive a lab request, then, in step 447, a determination is made as to whether server 110 received a request for information about a particular drug. If server 110 received a request for drug information, then, in step 448, web control 501 searches the requested drug information in drug information database 513. In step 449, web control 501 transmits the requested drug information to hand-held computer 120.

If server 110 did not receive a request for drug information, then, in step 450, a determination is made by server 110 as to whether the user is finished creating the current encounter template. If the user is finished creating the current encounter template, then method 400 is terminated in step 451. If the user is not finished creating the current encounter template, then in step 415, the next records or HTML web pages to be transmitted to the user of hand-held computer 120 are selected by referencing sequence database 509 and based upon the user's input, i.e., based upon the user's selection when provided a list of choices as discussed above.

Although the method, computer program product and system are described in connection with several embodiments, it is not intended to be limited to the specific forms set forth herein, but on the contrary, it is intended to cover such alternatives, modifications and equivalents, as can be reasonably included within the spirit and scope of the invention as defined by the appended claims. It is noted that the headings are used only for organizational purposes and not meant to limit the scope of the description or claims.

### Element List for the Encounter Template Programmer

| Element Types | Data Type Code |
|---|---|
| Branch Conditions | |
| Branch | BR |
| Branch Question | BQ |
| Branch Custom | BC |
| Branch To Template | BT |
| Checkboxes | |
| Checkbox | C |
| Checkbox Plus | C+ |
| Checkbox with Branch | CB |
| Checkbox Plus with Branch | C+B |
| Checkbox with Explanation | CE |
| Display Types | |
| Display Local Data | DLD |
| Display Local Data/Edit | DLE |
| Display Template Data | DTD |
| Display Current Date | DCD |
| Display Current Time | DCT |
| Dropdown Lists | |
| Dropdown | D |
| Dropdown/Fill-In | DF |
| Dropdown with Branch | DB |
| Dropdown/Fill-In with Branch | DFB |
| Link Field | L |
| Range Field | R |
| Fill-in Fields | |
| Fill-In | F |
| Ordered Fill-In | OF |
| Look and Feel | |
| Background Color | BG |
| Base Font Color | BF |
| Blank Record | BL |
| Title Record | T |
| Questions | |
| Question | Q |
| Question Custom | QC |
| Question with Explanation | QE |
| Radio Buttons | |
| Radio Button | RO |
| Radio Button List | RL |
| Radio Button with Branch | ROB |
| Radio Button List with Branch | RLB |
| Radio Button Horizontal | RH |
| Radio Button Horizontal with Branch | RHB |
| Screen Selection | |
| Screen Selection List | SSL |
| Screen Selection Radio | SSR |
| Screen Selection/Branch | SSB |
| Template Return | TR |
| Wizards | |
| Voice File Checkbox | |
| Medication/Rx Righter | |
| Rx Righter | |
| Y/N/NA Horizontal Radio | |

[image]

[image]

[image]

[image]

[image]

[image]

[image]

[image]

[image]

1. A method for creating records using a hand held device capable of recording a voice file comprising the steps of:
receiving a request to select an encounter template;
transmitting one or more screens of said selected encounter template;
receiving a request to generate a voice file to be inserted at a selected field in one of said one or more screens;
generating a tag file in response to said request to generate said voice file, wherein said tag file associates said voice file with said selected field in one of said one or more screens; and
transmitting said tag file to a requesting device.

2. The method as recited in claim 1, wherein said tag file comprises at least one of the following: a tracking number, a voice file sequence number, a topic, and an Internet Protocol address.

3. The method as recited in claim 1 further comprising the steps of:
receiving said voice file; and
transmitting said received voice file to be transcribed.

4. The method as recited in claim 3 further comprising the steps of:
receiving said transcribed voice file; and
integrating said transcribed voice file in said encounter template using said tag file.

5. The method as recited in claim 4 further comprising the step of:
verifying accuracy of said transcribed voice file prior to integrating said transcribed voice file in said selected encounter template.

6. The method as recited in claim 1 further comprising the steps of:
receiving said voice file; and
transcribing said received voice file.

7. The method as recited in claim 6 further comprising the step of:
integrating said transcribed voice file in said selected encounter template using said tag file.

8. The method as recited in claim 1 further comprising the step of:
transmitting a set of screens, wherein a first of said set of screens being operable for selecting an environment, wherein a second of said set of screens being operable for selecting said encounter template.

9. The method as recited in claim 8 further comprising the steps of:
receiving results as a user completes each of said one or more transmitted screens of said selected encounter template; and
recording results as said user completes each of said one or more transmitted screens of said selected encounter template.

10. The method as recited in claim 9 further comprising the step of:
selecting a next one or more screens to be transmitted upon said user completing said one or more transmitted screens of said selected encounter template.

11. The method as recited in claim 10, wherein said selection of said next one or more screens to be transmitted is based on said results received.

12. The method as recited in claim 11, wherein said selection of said next one or more screens to be transmitted is effected by referencing a database containing a sequence of screens to be transmitted for said selected encounter template.

13. The method as recited in claim 1 further comprising the steps of:
receiving a request to write a prescription;
receiving a name of a prescribed drug; and
checking said name of said prescribed drug against a patient profile.

14. The method as recited in claim 13 further comprising the step of:
transmitting a notification indicating a problem with prescribing said prescribed drug if there exists a problem with prescribing said prescribed drug.

15. The method as recited in claim 13 further comprising the step of:
printing out said prescription.

16. The method as recited in claim 13 further comprising the step of:
transmitting said prescription for filling.

17. The method as recited in claim 1 further comprising the step of:
receiving a request for drug information.

18. The method as recited in claim 17 further comprising the steps of:
searching said requested drug information in a database; and
transmitting said requested drug information.

19. A computer program produce embodied in a machine readable medium for creating records using a hand held device capable of recording a voice file comprising the programming steps of:
receiving a request to select an encounter template;
transmitting one or more screens of said selected encounter template;
receiving a request to generate a voice file to be inserted at a selected field in one of said one or more screens;
generating a tag file in response to said request to generate said voice file, wherein said tag file associates said voice file with said selected field in one of said one or more screens; and
transmitting said tag file to a requesting device.

20. The computer program product as recited in claim 19, wherein said tag file comprises at least one of the following: a tracking number, a voice file sequence number, a topic, and an Internet Protocol address.

21. The computer program product as recited in claim 19 further comprising the programming steps of:
receiving said voice file; and
transmitting said received voice file to be transcribed

22. The computer program product as recited in claim 21 further comprising the programming steps of:
receiving said transcribed voice file; and
integrating said transcribed voice file in said encounter template using said tag file.

23. The computer program product as recited in claim 22 further comprising the programming step of:
verifying accuracy of said transcribed voice file prior to integrating said transcribed voice file in said selected encounter template.

24. The computer program product as recited in claim 19 further comprising the programming steps of:
receiving said voice file; and
transcribing said received voice file.

25. The computer program product as recited in claim 24 further comprising the programming step of integrating said transcribed voice file in said selected encounter template using said tag file.

26. The computer program product as recited in claim 19 further comprising the programming step of:
transmitting a set of screens, wherein a first of said set of screens being operable for selecting an environment, wherein a second of said set of screens being operable for selecting said encounter template.

27. The computer program product as recited in claim 26 further comprising the programming steps of:
receiving results as a user completes each of said one or more transmitted screens of said selected encounter template; and
recording results as said user completes each of said one or more transmitted screens of said selected encounter template.

28. The computer program product as recited in claim 27 further comprising the programming step of:
selecting a next one or more screens to be transmitted upon said user completing said one or more transmitted screens of said selected encounter template.

29. The computer program product as recited in claim 28, wherein said selection of said next one or more screens to be transmitted is based on said results received.

30. The computer program product as recited in claim 28, wherein said selection of said next one or more screens to be transmitted is effected by referencing a database containing a sequence of screens to be transmitted for said selected encounter template.

31. The computer program product as recited in claim 19 further comprising the programming steps of:
receiving a request to write a prescription;
receiving a name of a prescribed drug; and
checking said name of said prescribed drug against a patient profile.

32. The computer program product as recited in claim 31 further comprising the programming step of:
transmitting a notification indicating a problem with prescribing said prescribed drug if there exists a problem with prescribing said prescribed drug.

33. The computer program product as recited in claim 31 further comprising the programming step of:
printing out said prescription.

34. The computer program product as recited in claim 31 further comprising the programming step of: transmitting said prescription for filling.

35. The computer program product as recited in claim 19 further comprising the step of:
receiving a request for drug information.

36. The computer program product as recited in claim 35 further comprising the programming steps of:
searching said requested drug information in a database; and
transmitting said requested drug information.

37. A system, comprising:
a memory unit operable for storing a computer program operable for creating records; and
a processor coupled to said memory unit, wherein said processor, responsive to said computer program, comprises:
circuitry operable for receiving a request to select an encounter template;
circuitry operable for transmitting one or more screens of said selected encounter template;
circuitry operable for receiving a request to generate a voice file to be inserted at a selected field in one of said one or more screens;
circuitry operable for generating a tag file in response to said request to generate said voice file, wherein said tag file associates said voice file with said selected field in one of said one or more screens; and
circuitry operable for transmitting said tag file to a requesting device.

38. The system as recited in claim 37, wherein said tag file comprises at least one of the following: a tracking number, a voice file sequence number, a topic, and an Internet Protocol address.

39. The system as recited in claim 37, wherein said processor further comprises:
circuitry operable for receiving said voice file; and
circuitry operable for transmitting said received voice file to be transcribed.

40. The system as recited in claim 39, wherein said processor further comprises:
circuitry operable for receiving said transcribed voice file; and
circuitry operable for integrating said transcribed voice file in said encounter template using said tag file.

41. The system as recited in claim 40, wherein said processor further comprises:
circuitry operable for verifying accuracy of said transcribed voice file prior to integrating said transcribed voice file in said selected encounter template.

42. The system as recited in claim 37, wherein said processor further comprises:
circuitry operable for receiving said voice file; and
circuitry operable for transcribing said received voice file.

43. The system as recited in claim 42, wherein said processor further comprises:
circuitry operable for integrating said trans%nWed voice file in said selected encounter template using said tag file.

44. The system as recited in claim 37, wherein said processor further comprises:
circuitry operable for transmitting a set of screens, wherein a first of said set of screens being operable for selecting an environment, wherein a second of said set of screens being operable for selecting said encounter template.

45. The system as recited in claim 44, wherein said processor further comprises:
circuitry operable for receiving results as a user completes each of said one or more transmitted screens of said selected encounter template; and
circuitry operable for recording results as said user completes each of said one or more transmitted screens of said selected encounter template.

46. The system as recited in claim 45, wherein said processor further comprises:
circuitry operable for selecting a next one or more screens to be transmitted upon said user completing said one or more transmitted screens of said selected encounter template.

47. The system as recited in claim 46, wherein said selection of said next one or more screens to be transmitted is based on said results received.

48. The system as recited in claim 46, wherein said selection of said next one or more screens to be transmitted is effected by referencing a database containing a sequence of screens to be transmitted for said selected encounter template.

49. The system as recited in claim 37, wherein said processor further comprises:
circuitry operable for receiving a request to write a prescription;
circuitry operable for receiving a name of a prescribed drug; and
circuitry operable for checking said name of said prescribed drug against a patient profile.

50. The system as recited in claim 49, wherein said processor further comprises:
circuitry operable for transmitting a notification indicating a problem with prescribing said prescribed drug if there exists a problem with prescribing said prescribed drug.

51. The system as recited in claim 49, wherein said processor further comprises:
circuitry operable for printing out said prescription.

52. The system as recited in claim 49, wherein said processor further comprises:
circuitry operable for transmitting said prescription for filling.

53. The system as recited in claim 37, wherein said processor further comprises:
circuitry operable for receiving a request for drug information.

54. The system as recited in claim 53, wherein said processor further comprises:
circuitry operable searching said requested drug information in a database; and
circuitry operable transmitting said requested drug information.
